(19) United States
(12) Patent Application Publication
(10) Pub. No.: US 2025/0338122 A1
(43) Pub. Date: Oct. 30, 2025

(54) MANAGING SECURE ACCESS TO WIRELESS CONNECTION CREDENTIALS

(71) Applicant: Dell Products L.P., Round Rock, TX (US)

(72) Inventors: VINODKUMAR VASUDEV OTTAR, McKinney, TX (US); ABEYE TESHOME, Austin, TX (US); RICHARD M. TONRY, Georgetown, TX (US); BASSEM EL-AZZAMI, Austin, TX (US); MOHIT ARORA, Frisco, TX (US); LUIS ANTONIO VALENCIA REYES, Waxahachie, TX (US); ADOLFO SANDOR MONTERO, Pflugerville, TX (US); RAJARAVI CHANDRA KOLLARAPU, Allen, TX (US)

(21) Appl. No.: 18/649,163

(22) Filed: Apr. 29, 2024

(51) Int. Cl. H04W 12/08; H04W 12/06

(52) U.S. Cl. CPC H04W 12/08; H04W 12/068

(57) ABSTRACT

Methods and systems for managing wireless communications by a data processing system are disclosed. The method may include intercepting a request for access to credentials for the wireless communications by a kernel driver. The kernel driver may operate in a kernel mode of an operating system hosted by hardware resources of the data processing system. When the request is obtained by the kernel driver, a requestor of the request may be identified and permission to access the credentials by the requestor may be identified. If the requestor (e.g., a network stack hosted by the data processing system) is identified to have permissions, the request may be rerouted to a management controller of the data processing system. The credentials may be stored in secure storage hosted by the management controller. The management controller may provide use of the credentials to the requestor for use in establishing wireless communications.

### FIELD

Embodiments disclosed herein relate generally to managing wireless communications by a data processing system. More particularly, embodiments disclosed herein relate to managing wireless communications by a data processing system by rerouting requests for access to wireless connection credentials to a management controller.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1C show diagrams illustrating a system in accordance with an embodiment.

FIG. 2 shows an interaction diagram in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing wireless communications by a data processing system. The data processing system may provide computer-implemented services to any type and number of other devices and/or users of the data processing system. The computer-implemented services may include any quantity and type of such services.

To provide the computer-implemented services, the data processing system may wirelessly communicate with other devices while connected to a wireless network. To connect to the wireless network, the data processing system may provide credentials when requesting to establish a secure connection to the wireless network. The credentials may include, for example, a network name (e.g., a service set identifier (SSID)), a password, and/or any other information.

Because the data processing system may connect to different wireless networks at different times, any number of credentials may be stored in hardware resources (e.g., in memory, registers, storage, etc.) hosted by the data processing system and accessed for use in establishing repeated connections to the different wireless networks.

However, the data processing system may be subject to undesired use if the credentials are obtained and used by an unauthorized user. Once connected to the wireless network using the credentials accessed from the hardware resources of the data processing system, the unauthorized user (e.g., a malicious entity) may perform malicious activity that may negatively impact the data processing system. For example, impacts of undesired use of the data processing system may include reduced data security and/or increased likelihood of interruptions to desired computer-implemented services provided by the data processing system.

To reduce impacts of undesired use of credentials for wireless communications, the credentials may be stored on a management controller of the data processing system rather than in the hardware resources and requests to access the credentials may be filtered. To do so, requests to access the credentials on a destination hosted in the hardware resources may be intercepted by a kernel driver.

The kernel driver may identify the requestor and determine whether the requestor has permissions to access the credentials. To determine if the requestor has permissions, the kernel driver may compare an identify of the requestor to trusted identities (e.g., a network stack) specified in whitelist. If the requestor is determined to have the permissions, the kernel driver may reroute the request to the management controller.

To manage use of the data processing system, the data processing system may include out-of-band components (e.g., including the management controller). Because the out-of-band components may function independently from in-band components (e.g., including the hardware resources), the management controller may provide secure storage for the credentials if the hardware resources of the data processing system are compromised.

Thus, embodiments disclosed herein may provide an improved method for managing wireless communications by a data processing system by dynamically rerouting requests for access to credentials to a management controller. By doing so, access to the credentials may be protected from unauthorized users and subsequently, the data processing system may provide computer-implemented services while using a secured wireless connection.

In an embodiment, a method for managing wireless communications by a data processing system is provided. The method may include: (i) identifying a request for access to credentials for the wireless communications; (ii) identifying a requestor of the request; (iii) in the first instance of the identifying where the requestor has permission to access the credentials: (a) rerouting the request to a management controller of the data processing system; (b) identifying, by the management controller and based on the request, a copy of the credentials stored in secure storage of the management controller; and (c) providing, by the management controller, use of the copy of the credentials to the requestor to facilitate the wireless communications; and (iv) in a second instance of the identifying where the requestor does not have permission to access the credentials: (a) allow the request to be routed to a destination as specified in the request rather than rerouting the request.

Identifying a request for access to credentials may include intercepting requests directed to a destination on hardware resources of the data processing system where the credentials are normally stored by a management entity of the data processing system.

Intercepting requests may include obtaining input/output data directed to the destination.

Rerouting the request may include directing the request to the management controller rather than to the destination, via a sideband communication channel and/or an out-of-band communication channel.

Providing use of the copy of the credentials may include providing the copy of the credentials to the requestor, via the sideband communication channel and/or the out-of-band communication channel.

The copy of the credentials may be used by the requestor to establish a connection to a wireless network.

The requestor may be an entity hosted by hardware resources of the data processing system.

Identifying whether the requestor has permissions may include (i) obtaining a whitelist, the whitelist specifying identities of entities permitted to access the credentials; and (ii) matching an identity of the requestor with an identify of identities in the whitelist.

The data processing system may include hardware resources and a network module adapted to separately advertise network endpoints for the management controller and the hardware resources of the data processing system, the network endpoints being usable by a server system to address communications to the hardware resources using an in-band communication channel and the management controller using an out-of-band communication channel.

The management controller and the network module may be on separate power domains from the hardware resources so that the management controller and the network module are operable while the hardware resources are inoperable.

The out-of-band communication channel may run through the network module, and an in-band communication channel that services the hardware resources may also run through the network module.

The network module may host a transmission control protocol/internet protocol (TCP/IP) stack to facilitate network communications via the out-of-band communication channel.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

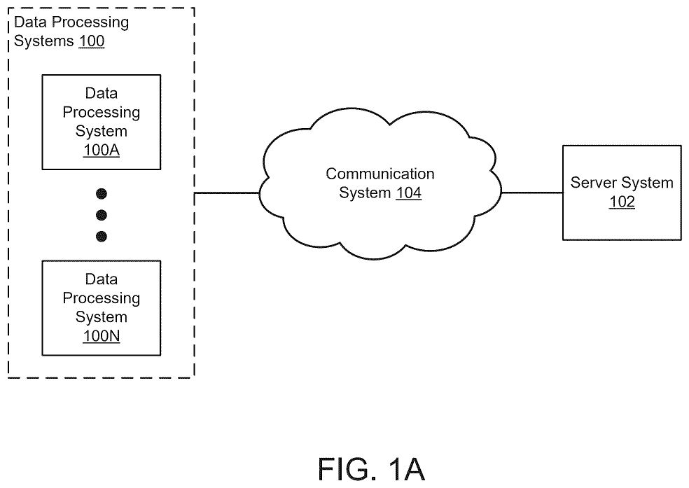

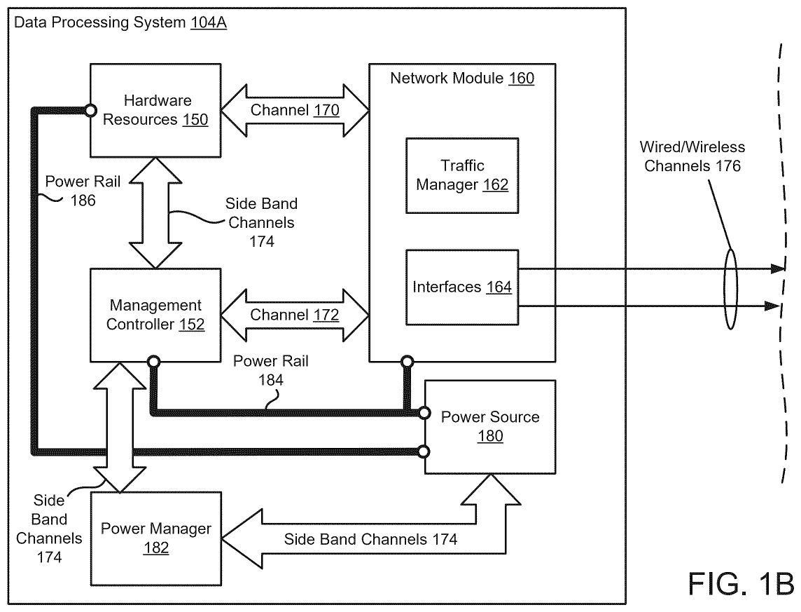

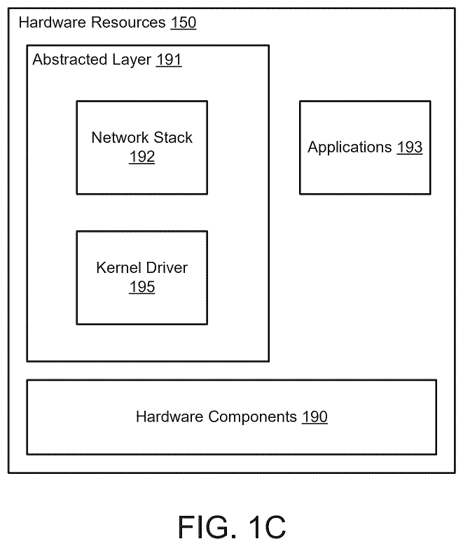

Turning to FIG. 1A, a distributed environment in accordance with an embodiment is shown. The distributed environment (e.g., the system) shown in FIG. 1A may provide for management of data processing systems that may provide, at least in part, computer-implemented services (e.g., to user of the system and/or devices operably connected to the system).

The system may include any number of data processing systems 100 (e.g., computing devices) that may each include any number of hardware components (e.g., processors, memory modules, storage devices, communication devices, etc.). The hardware components may support execution of any number and types of applications (e.g., software components). Changes in available functionalities of the hardware and/or software components may provide for various types of different computer-implemented services to be provided over time. Refer to FIGS. 1B-1C for additional details regarding data processing systems 100.

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, data processing systems 100, server system 102, and/or any other type of devices (not shown in FIG. 1A). Other types of computer-implemented services may be provided by the system shown in FIG. 1A without departing from embodiments disclosed herein.

To provide the computer-implemented services, the data processing system may wirelessly communicate information with other devices (e.g., server systems, other data processing systems, etc.) while connected to a wireless network. To connect to the wireless network, the data processing system may provide credentials when requesting to establish a secure connection to the wireless network. The credentials may include, for example, a network name (e.g., a service set identifier (SSID)), a password, and/or any other information.

The data processing system may establish different wireless connections at different times based on a quality and/or availability of a wireless network. To manage the credentials necessary to establish future connections to any of the different wireless networks, the credentials may be stored in hardware resources of the data processing system. For example, the credentials may be stored in plaintext format (e.g., unencrypted, human-readable, etc.) in memory, registers, and/or other storage hosted by the hardware resources. The credentials may be requested and used by an entity requesting to establish a wireless connection to a corresponding network.

However, the data processing system may be subject to undesired use if the credentials are obtained and used by an unauthorized user. Once connected to the wireless network using the credentials, the unauthorized user (e.g., a malicious entity) may perform malicious activity that may negatively impact the data processing system. For example, the unauthorized user may obtain information regarding the data processing system (e.g., network endpoint addresses), obtain sensitive information sent/received over the wireless connection, perform compromising actions on behalf of the data processing system, and/or perform any other undesired actions. Impacts of the undesired use of the data processing system may include reduced data security and/or increased likelihood of interruptions to desired computer-implemented services provided by the data processing system.

In general, embodiments disclosed herein may provide methods, systems, and/or devices for managing wireless communications by a data processing system. To reduce impacts of undesired use of credentials for wireless communications, the credentials may be stored on a management controller of the data processing system rather than in the hardware resources and requests to access the credentials may be filtered based on an identity of the requestor.

Because the management controller may function independently from in-band components (e.g., including the hardware resources), the management controller may provide secure storage for the credentials if the hardware resources of the data processing system are compromised (e.g., by the unauthorized user). For example, the credentials may be stored in storage (e.g., a cache) hosted by the management controller and communication between in-band components of the data processing system and the management controller may occur without traversing in-band communication channels.

When a request to access the credentials in the hardware resources is obtained, the request may be filtered by a kernel driver hosted by the hardware resources to reroute some requests to the management controller. To do so, the kernel driver may: (i) intercept a request directed to a destination (e.g., a memory address) in hardware resources where the credentials are normally stored (e.g., may depend on the management system in place), (ii) identify an identify of a requestor of the request, (iii) determine if the requestor has permissions to access the credentials, (iv) reroute the request to the management controller to process the request if the requester is determined to have the permissions, and/or perform other actions.

To perform its functions, the kernel driver may operate in a kernel mode (e.g., of an operating system of the data processing system). While operating in kernel mode, the kernel driver may have privileged access to components and/or processes of the hardware resources (e.g., for intercepting requests). Furthermore, to determine if the requestor has permissions, the kernel driver may obtain a whitelist and compare an identify of the requestor to trusted identities specified in the whitelist. The trusted identities may include, for example, a network stack hosted by the hardware resources.

If the requestor is determined to have the permissions, the kernel driver may reroute the request to the management controller. To reroute the request, the request may be directed across a sideband communication channel and/or an out-of-band communication channel to the management controller. The management controller may identify a copy of the credentials based on the request and provide the copy of the credentials to the requestor for use in establishing wireless communications.

To provide the above noted functionality, the system may include data processing systems 100, and server system 102. Each of these components is discussed below.

Data processing systems 100 may include any number of data processing systems (e.g., 100A-100N) that may individually and/or cooperatively provide at least a portion of the computer-implemented services. Any of data processing systems 100 may include in-band components (e.g., hardware resources), out-of-band components (e.g., management controller, network modules, etc.), and functionality that may allow the out-of-band components to communicate with server system 102 via an out-of-band communication channel.

To enable wireless communication, a data processing system (e.g., 100A) of data processing systems 100 may store any number of credentials (e.g., a network name, SSID, password, etc.) for use in establishing wireless connections to networks. Entities (e.g., applications, network components, etc.) hosted by data processing system 100A may request access to the credentials while in operation. To facilitate desired use of the credentials, access to the credentials may be provided to permitted requestors. By doing so, data processing systems 100 may manage secure sharing of wireless communication credentials to reduce a likelihood of interruptions in the computer-implemented services.

Server system 102 may, as discussed above, provide remote management services. To provide remote management services, server system 102 may wirelessly communicate with data processing systems 100. Server system 102 may interact with data processing systems 100 to provide instructions regarding operation of data processing systems 100 and/or updates to the computer-implemented services provided by data processing systems 100. For example, server system 102 may send instructions relevant to management of any number of data processing systems in data processing systems 100 across an out-of-band communication channel.

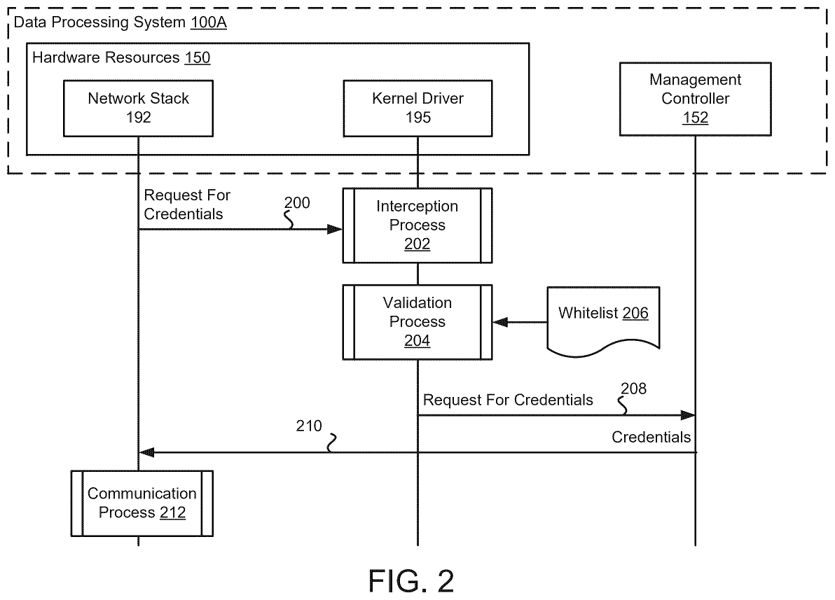

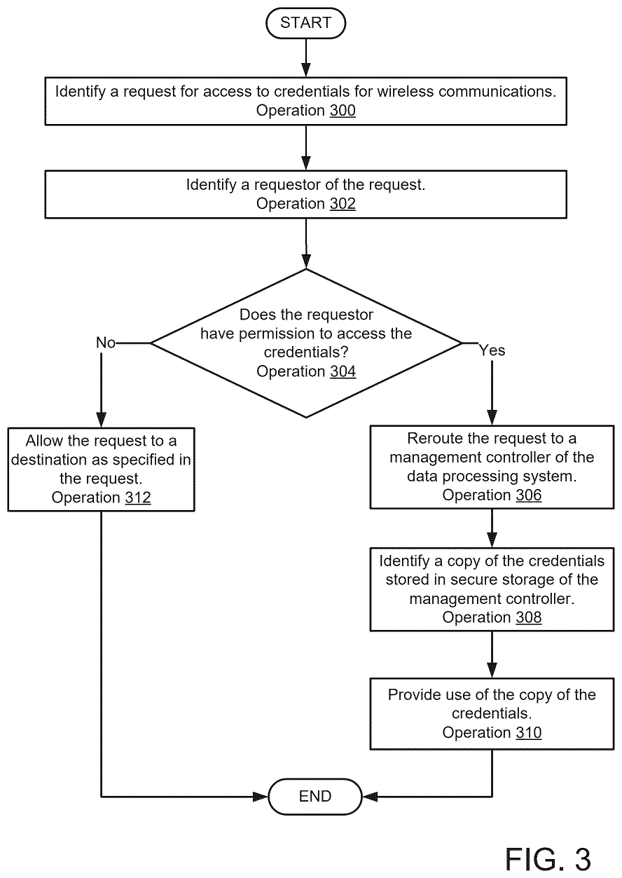

While providing their functionality, any of data processing systems 100 and/or server system 102 may provide all or a portion of the methods shown in FIGS. 2-3.

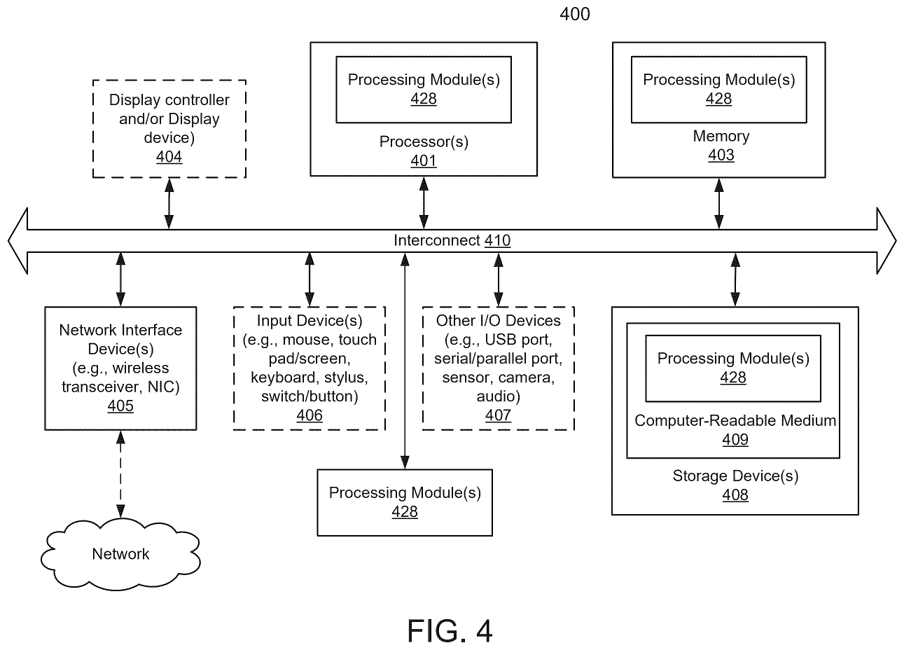

Communication system 104 may allow any of data processing systems 100, and server system 102 to communicate with one another (and/or with other devices not illustrated in FIG. 1A). To provide its functionality, communication system 104 may be implemented with one or more wired and/or wireless networks. Any of these networks may be a private network (e.g., the “Network” shown in FIG. 4), a public network, and/or may include the Internet. For example, data processing systems 100 may be operably connected to server systems 102 via the Internet. Data processing systems 100, server system 102, and/or communication system 104 may be adapted to perform one or more protocols for communicating via communication system 104.

Any of (and/or components thereof) data processing systems 100, and server system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1A, a system in accordance with an embodiment may manage wireless communications by data processing systems 100 by intercepting requests for access to credentials and securely sharing the credentials with entities that may require the credentials for desired operation. By doing so, negative impacts on computer-implemented services caused by unauthorized use of the credentials may be reduced.

While illustrated in FIG. 1A with a limited number of specific components, a system may include additional, fewer, and/or different components without departing from embodiments disclosed herein.

Turning to FIG. 1B, a diagram illustrating a data processing system in accordance with an embodiment is shown. Data processing system 100A shown in FIG. 1B may be similar to any of the data processing systems shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components.

The processor may host various management entities such as operating systems, drivers, network stacks, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing hardware resources 150 to communicate with other devices via packet switched networks and/or other types of communication networks. Refer to FIG. 1C for additional details regarding the network stack.

The processor may also host various applications that provide the computer-implemented services. The applications may utilize various services provided by the management entities and use (at least indirectly) the network stack to communication with other entities. Refer to FIG. 1C for additional details regarding the applications.

If the applications hosted by hardware resources 150 are unable to communicate with the other entities due to an inability to access a wireless network with certain credentials, the applications may be unable to provide the computer-implemented services. For example, a user of data processing system 100A may be unable to obtain desired services and/or a quality of user experience may be diminished when applications are unable to wirelessly communicate with other entities.

To improve a likelihood that the applications may be able to wirelessly communicate with other entities without interruption, credentials may be securely shared with an entity (e.g., the network stack) that may use the credentials directly (e.g., without exposing the credentials in plaintext to the application and/or user of the application) to establish wireless connections. To manage the sharing of the credentials, data processing system 100A may include management controller 152 and network module 160. Each of these components of data processing system 100A is discussed below.

Management controller 152 may be implemented, for example, using a system on a chip or other type of independently operating computing device (e.g., independent from the in-band components, such as hardware resources 150, of a host data processing system 100A). Management controller 152 may provide various management functionalities for data processing system 100A. For example, management controller 152 may monitor various ongoing processes performed by the in-band component, may manage power distribution, thermal management, and/or other functions of data processing system 100A.

To do so, management controller 152 may be operably connected to various components via sideband channels 174 (in FIG. 1B, a limited number of sideband channels are included for illustrative purposes, it will be appreciated that management controller 152 may communication with other components via any number of sideband channels). The sideband channels may be implemented using separate physical channels, and/or with a logical channel overlay over existing physical channels (e.g., logical division of in-band channels). The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), credential storage services, and/or other types of management functionalities.

For example, to provide credential storage services, management controller 152 may obtain credentials established by hardware resources 150, store the credentials in storage (e.g., a cache) hosted by management controller 152, and/or provide the credentials based on a request. To obtain the credentials, management controller 152 may receive the credentials from hardware resources 150 via a secure transmission method (e.g., public-private key pair encryption). To provide the credentials, management controller may search the storage based on the request and transmit at least a copy of the credentials to the requestor via a sideband and/or an out-of-band communication channel.

Management controller 152 may be operably connected to communication components of data processing system 100A via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted component may not result in indirect compromise of any management controller 152, and entities hosted by management controller 152.

To facilitate communication with other devices, data processing system 100A may include network module 160. Network module 160 may provide communication services for in-band components and out-of-band components (e.g., management controller 152) of data processing system. To do so, network module 160 may include traffic manager 162 and interfaces 164.

Traffic manager 162 may include functionality to (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100A may appear to be two independent network entities, that may independently addressable, and otherwise unrelated to one another.

To provide its functionality, management controller 152 may rely on information received from other devices via wireless communication over an out-of-band communication channel (e.g., 172). However, the information may include sensitive information regarding hardware resources 150 and may be restricted from being transmitted to management controller 152 if management controller 152 and hardware resources are treated as separate devices based on the separate network endpoints. Restriction of information may disrupt functionalities provided by management controller 152.

To facilitate management of data processing system 100A over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails. Management controller 152 may cooperate with power manager 182 to manage supply of power to these power domains.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, management controller 152 may perform all, or a portion, of the methods and operations illustrated in FIGS. 2-3.

While illustrated in FIG. 1B with a limited number of specific components, a system may include additional, fewer, and/or different components without departing from embodiments disclosed herein.

Turning to FIG. 1C, to provide computer-implemented services, hardware resources 150 may host applications 193 and abstraction layer 191. Abstraction layer 191 may include, for example, software, drivers, operating systems, and/or other entities that facilitate operation of applications 193 by facilitating abstracted access to hardware components 190. Hardware components 190 may include processors, memory modules, storage devices, and/or other types of hardware components usable to provide computer-implemented services.

Applications 193 may provide any quantity and type of computer-implemented services using hardware components 190. When operating, applications 193 may use abstracted access to the functionality of hardware components 190 provided by abstraction layer 191. For example, the applications may make calls to an operating system which in turn makes calls to drivers which in turn communicate with the hardware components to invoke their various functionalities. To provide the computer-implemented services, applications 193 may wirelessly communicate with other devices by using (at least indirectly) network stack 192.

To enable wireless communication, abstraction layer 191 may also host network stack 192. To provide its functionality, network stack 192 may establish a connection with a wireless network. To do so, the network stack may send a request for credentials which may include, for example, a network name, passwords, tokens, and/or any other information. Once obtained, the credentials may be used by network stack 192 to establish wireless communications and/or authenticate data to send to other devices. Because use of the credentials by network stack 192 may be encapsulated (e.g., not directly visible/accessible to entities outside of network stack 192), based on a request for access to the credentials, the credentials may be directly provided to network stack 192 for secure usage.

Because applications 193 may operate in a user mode (e.g., of an operating system hosted by hardware resources 150), sensitive information including the credentials may be directly accessible to a user of applications 193. If a user of applications 193 is a malicious entity, the credentials may be used to perform undesired actions and subsequently negatively impact computer-implemented services provided by data processing system 100A.

To improve the likelihood that the credentials may be used for secure wireless communication without exposing the credentials (e.g., in plaintext to applications 193 and/or a user of the applications 193), abstraction layer 191 may also host kernel driver 195. Kernel driver 195 may be configured to intercept requests made to a destination (e.g., a memory address) in hardware components 190 and reroute permitted requests to management controller 152.

To perform its functions, kernel driver 195 may operate in a kernel mode (e.g., of an operating system hosted by hardware resources 150). While operating in kernel mode, the kernel driver may have privilege access to components and/or processes of hardware resources 150 (e.g., for intercepting requests). Furthermore, to determine if a requestor of a request to access the credentials has permissions, the kernel driver may obtain a whitelist and compare an identify of the requestor to trusted identities specified in the whitelist. The trusted identities may include, for example, network stack 192.

If the requester is determined to not have access (e.g., directly requested by applications 193), kernel driver 195 may allow the request to be routed to the destination on hardware components 190. Because the credentials may not be stored in the destination, the request may not be fulfilled (e.g., a copy of the credentials may not be provided to the requestor).

However, if the requestor is determined to have access (e.g., requested by network stack 192), kernel driver 195 may reroute the request to management controller 152. Management controller 152 may provide at least a copy of the credentials to the requestor for use in establishing wireless communications.

While illustrated in FIG. 1C with a limited number of specific components, a system may include additional, fewer, and/or different components without departing from embodiments disclosed herein.

Thus, as shown in FIG. 1C, a kernel diver may facilitate secure sharing of credentials to a network stack for wireless communication by rerouting requests for access to credentials based on an identity of a requestor.

To further clarify embodiments disclosed herein, an interaction diagram in accordance with an embodiment is shown in FIG. 2. The interaction diagram may illustrate how data may be obtained and used within the system of FIGS. 1A-1C.

In the interaction diagram, processes performed by and interactions between components of a system in accordance with an embodiment are shown. In the diagram, components of the system are illustrated using a first set of shapes (e.g., 192, 195, etc.), located towards the top of each figure. Lines descend from these shapes. Processes performed by the components of the system are illustrated using a second set of shapes (e.g., 202, 204, etc.) superimposed over these lines. Interactions (e.g., communication, data transmissions, etc.) between the components of the system are illustrated using a third set of shapes (e.g., 200, 208, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 200 may occur prior to the interaction labeled as 208. However, it will be appreciated that the processes and interactions may be performed in different orders, any may be omitted, and other processes or interactions may be performed without departing from embodiments disclosed herein.

Turning to FIG. 2, an interaction diagram in accordance with an embodiment is shown. The interaction diagram may illustrate processes and interactions that may occur during rerouting of requests to access credentials for wireless communication.

At interaction 200, a request for credentials may be provided by network stack 192. The request for credentials may include, for example, an identifier of a wireless network requesting to be connected to, a destination in hardware resources where the credentials may normally be stored, and/or any other information. The request may be generated and provided to kernel driver 195 via (i) transmission via a message, (ii) identification of the request by kernel driver 195, (iii) via a publish-subscribe system where kernel driver 195 subscribes to updates from network stack 192 thereby causing a copy of the request for credentials to be propagated to kernel driver 195, and/or via other processes. By providing the request for credentials, kernel driver 195 may provide rerouting services.

To identify the request for access to credentials, interception process 202 may be performed. During interception request 202, requests for credentials may be intercepted by kernel driver 195. For example, to intercept the requests, kernel driver 195 may: (i) monitor data transmission directed to a destination on hardware resources 150 where credentials are normally stored, (ii) identify contents of the request, (iii) prevent the request from transmitting to the destination as requested, and/or any other actions. Once identified, the request may be processed in validation process 204.

To process the request for rerouting, validation process 204 may be performed. During validation process 204, permissions for a requestor of the request may be identified, and a flow of the request may be controlled. To identify permissions for the requestor, kernel driver 195 may: (i) obtain identities of trusted entities from whitelist 206, (ii) attempt to match an identity of the requestor to identities specified in whitelist 206, and/or any other actions.

Whitelist 206 may include any type and quantity of information regarding entities that may have permissions to access credentials for wireless communication. For example, whitelist 206 may include an application identifier, a network endpoint address (e.g., a media access control access address, internet protocol address, etc., and/or any other identifier. Whitelist 206 may be organized, for example, as a list, file, and/or any other data structure hosted on hardware resources 150. Whitelist 206 may be used by kernel driver 195 to determine permissions for a requestor of a request to access credentials.

To control a flow of the request, kernel driver 195 may: (i) reroute the request to management controller 195 if the requestor is determined to have permissions (e.g., an identity of the requestor is included in whitelist 206), (ii) allow the request to transmit to the destination specified in the request (e.g., where the credentials may not be stored and subsequently access to the credentials may not be provided to the requestor) if the requestor is determined to not have credentials (e.g., an identity of the requestor is not included in whitelist 206), and/or perform any other actions.

At interaction 208, the request to access credentials may be provided to management controller 152. For example, the request may be provided to management controller 152 via (i) changing a destination specified in the request to an address of management controller 152 instead of an address of hardware resources 150, (ii) generating and providing a new copy of the request to management controller 152, and/or any other processes. By providing the request to management controller 152, management controller may process the request to provide access to the credentials to network stack 192.

At interaction 210, the credentials may be provided to network stack 192 by management controller 152. For example, the credentials may be generated and provided by management controller 152 by: (i) searching a storage of the credentials using an identity of a network (e.g., a network name, a SSID, etc.) specified in the request as a key, (ii) packaging at least a copy of the credentials as a data package, (iii) transmitting the data package across a sideband and/or out-of-band communication channel to network stack 192, and/or any other processes. By providing a copy of the credentials to network stack 192, network stack 192 may establish wireless communications using the credentials.

To establish wireless communications, communications process 212 may be performed. During communication process 212, a wireless connection may be established to a wireless network, and data may be transmitted across a wireless communication channel. For example, to establish a wireless connection, network stack 192 may: (i) initiate an authentication process with a network access point of the wireless network, (ii) provide the credentials to the wireless network, (iii) establish a secured (e.g., encrypted) communication channel, and/or any other processes. To transmit data across the wireless communication channel, network stack 192 may (i) obtain data and/or requests for data from applications hosted by hardware resources 150, (ii) provide data transmission services (e.g., in data packages compatible with the communication channel, along a certain route, etc.), (iii) monitor a status of the wireless communications, (iv) provide responses to the applications of hardware resources 150, and/or any other processes. By doing so, data processing system 100A may obtain information necessary to provide computer-implemented services.

Thus, processes and interactions shown in FIG. 2, requests to access credentials for wireless communications may be rerouted between a network stack and a management controller of a data processing system. By doing so, the network stack may establish wireless communications to provide computer-implemented services while maintaining secure access to the credentials.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1A may perform various methods to manage a data processing system. FIG. 3 illustrates methods that may be performed by the components of the system of FIGS. 1A-1C. In the diagrams discussed below and shown in FIG. 3, any of the operations may be repeated, performed in different orders, and/or performed in parallel with or in a partially overlapping in time manner with other operations.

Turning to FIG. 3, a flow diagram illustrating a method of managing wireless communications by a data processing system in accordance with an embodiment is shown. The method may be performed, for example, by any of the components of the system of FIGS. 1A-1C, and/or other components not shown therein.

At operation 300, a request for access to credentials for wireless communications may be identified. The request may be identified by: (i) monitoring, by a kernel driver hosted by hardware resources of the data processing system, data transmission to a destination on the hardware resources (e.g., a memory address where the credentials are normally stored), (ii) intercepting the data transmission, (iii) identifying that the intercepted data includes a request to access credentials for wireless communication, and/or any other processes.

At operation 302, a requestor of the request may be identified. The requestor of the request may be identified by: (i) reading an identity (e.g., an endpoint address, an application name, etc.) of the requestor from the request, (ii) requesting information regarding an identify from the requestor, and/or any other methods.

At operation 304, an identification may be made regarding whether the requestor has permission to access the credentials. The identification may be made by: (i) obtaining a whitelist of identities of trusted entities that may have permission to access the credentials, (ii) performing a lookup in the whitelist using the identity of the requestor as a key, (iii) obtaining a lookup result indicating whether the requestor has permission (e.g., is included in the whitelist), and/or any other processes. If the requestor is identified to have permission to access the credentials (e.g., the determination is “Yes” at operation 304), then the method may proceed to operation 306. If the requestor is identified to not have permission to access the credentials (e.g., the determination is “No” at operation 304), then the method may proceed to operation 312.

At operation 306, the request may be rerouted to a management controller of the data processing system. The request may be rerouted by the kernel driver by (i) changing a destination specified in the request to an address of the management controller instead of an address of hardware resources, (ii) generating and providing a new copy of the request to the management controller, and/or any other processes.

At operation 308, a copy of the credentials stored in secure storage of the management controller may be identified by the management controller and based on the request. The copy of the credentials may be identified by (i) obtaining an identity (e.g., a SSID, a network name, etc.) of a wireless network requested by the request, (ii) performing a lookup in the secure storage (e.g., a cache) using the identity as a key, (iii) obtaining a lookup result including a copy of the credentials requested by the request, and/or any other processes.

At operation 310, use of the copy of the credentials may be provided to the requestor to facility the wireless communications. Use of the copy of the credentials may be provided by: (i) packaging the credentials as a data package, (iii) transmitting the data package across a sideband and/or out-of-band communication channel the requestor, and/or any other methods.

At operation 312, the request may be allowed to be routed to a destination as specified in the request rather than rerouting the request. The request may be allowed to be routed to the destination specified in the request by: (i) providing, by the kernel driver, the request to the destination (e.g., a memory address on hardware resources of the data processing system), (ii) voiding the request based on knowledge that the credentials are not stored in the destination, (iii) returning a message (e.g., null, error, inaccurate credentials, etc.) to the requestor, and/or any other processes.

The method may end following operation 310 or operation 312.

Using the method shown in FIG. 3, requests to access credentials for wireless communications by a data processing system may be securely managed by rerouting to a management controller of the data processing system. By doing so, an availability and/or security of computer-implemented services provided by the data processing system be improved.

Any of the components illustrated in FIGS. 1A-2 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing wireless communications by a data processing system, the method comprising:
identifying a request for access to credentials for the wireless communications;
identifying a requestor of the request;
identifying whether the requestor has permission to access the credentials;
in a first instance of the identifying where the requestor has permission to access the credentials:
rerouting the request to a management controller of the data processing system;
identifying, by the management controller and based on the request, a copy of the credentials stored in secure storage of the management controller; and
providing, by the management controller, use of the copy of the credentials to the requestor to facilitate the wireless communications; and
in a second instance of the identifying where the requestor does not have permission to access the credentials:
allow the request to be routed to a destination as specified in the request rather than rerouting the request.

2. A method of claim 1, wherein identifying a request for access to credentials comprises intercepting requests directed to a destination on hardware resources of the data processing system where the credentials are normally stored by a management entity of the data processing system.

3. A method of claim 2, wherein intercepting requests comprises obtaining input/output data directed to the destination.

4. A method of claim 2, wherein rerouting the request comprises directing the request to the management controller rather than to the destination, via a sideband communication channel and/or an out-of-band communication channel.

5. A method of claim 4, wherein providing use of the copy of the credentials comprises providing the copy of the credentials to the requestor, via the sideband communication channel and/or the out-of-band communication channel.

6. A method of claim 5, wherein the copy of the credentials is used by the requestor to establish a connection to a wireless network.

7. A method of claim 1, wherein the requestor is an entity hosted by hardware resources of the data processing system.

8. A method of claim 1, wherein identifying whether the requestor has permission comprises:
obtaining a whitelist, the whitelist specifying identities of entities permitted to access the credentials; and
matching an identity of the requestor with an identify of identities in the whitelist.

9. The method of claim 1, wherein the data processing system comprises hardware resources and a network module adapted to separately advertise network endpoints for the management controller and the hardware resources of the data processing system, the network endpoints being usable by a server system to address communications to the hardware resources using an in-band communication channel and the management controller using an out-of-band communication channel.

10. The method of claim 9, wherein the management controller and the network module are on separate power domains from the hardware resources so that the management controller and the network module are operable while the hardware resources are inoperable.

11. The method of claim 9, wherein the out-of-band communication channel runs through the network module, and an in-band communication channel that services the hardware resources also runs through the network module.

12. The method of claim 9, wherein the network module hosts a transmission control protocol/internet protocol (TCP/IP) stack to facilitate network communications via the out-of-band communication channel.

13. A non-transitory machine-readable medium having instructions stored therein, which when executed by a processor, cause the processor to perform operations for managing wireless communications by a data processing system, the operations comprising:
identifying a request for access to credentials for the wireless communications;
identifying a requestor of the request;
identifying whether the requestor has permission to access the credentials;
in a first instance of the identifying where the requestor has permission to access the credentials:
rerouting the request to a management controller of the data processing system;
identifying, by the management controller and based on the request, a copy of the credentials stored in secure storage of the management controller; and
providing, by the management controller, use of the copy of the credentials to the requestor to facilitate the wireless communications; and
in a second instance of the identifying where the requestor does not have permission to access the credentials:
allow the request to be routed to a destination as specified in the request rather than rerouting the request.

14. A non-transitory machine-readable medium of claim 13, wherein identifying a request for access to credentials comprises intercepting requests directed to a destination on hardware resources of the data processing system where the credentials are normally stored by a management entity of the data processing system.

15. A non-transitory machine-readable medium of claim 14, wherein intercepting requests comprises obtaining input/output data directed to the destination.

16. A non-transitory machine-readable medium of claim 14, wherein rerouting the request comprises directing the request to the management controller rather than to the destination, via a sideband communication channel and/or an out-of-band communication channel.

17. A data processing system, comprising:
a processor; and a memory coupled to the processor to store instructions, which when executed by the processor, cause the processor to perform operations for managing wireless communications by a data processing system, the operations comprising:
identifying a request for access to credentials for the wireless communications;
identifying a requestor of the request;
identifying whether the requestor has permission to access the credentials;
in a first instance of the identifying where the requestor has permission to access the credentials:
rerouting the request to a management controller of the data processing system;
identifying, by the management controller and based on the request, a copy of the credentials stored in secure storage of the management controller; and
providing, by the management controller, use of the copy of the credentials to the requestor to facilitate the wireless communications; and
in a second instance of the identifying where the requestor does not have permission to access the credentials:
allow the request to be routed to a destination as specified in the request rather than rerouting the request.

18. The data processing system of claim 17, wherein identifying a request for access to credentials comprises intercepting requests directed to a destination on hardware resources of the data processing system where the credentials are normally stored by a management entity of the data processing system.

19. The data processing system of claim 18, wherein intercepting requests comprises obtaining input/output data directed to the destination.

20. The data processing system of claim 19, wherein rerouting the request comprises directing the request to the management controller rather than to the destination, via a sideband communication channel and/or an out-of-band communication channel.
